(19) United States
(12) Patent Application Publication
(10) Pub. No.: US 2013/0021274 A1
(43) Pub. Date: Jan. 24, 2013

(54) ELECTRONIC APPARATUS AND CONTROL METHOD THEREFOR

(71) Applicants: Yuki Fukushima, Yokohama-shi (JP); Kento Inai, Zushi-shi (JP)

(72) Inventors: Yuki Fukushima, Yokohama-shi (JP); Kento Inai, Zushi-shi (JP)

(73) Assignee: CANON KABUSHIKI KAISHA, Tokyo (JP)

(21) Appl. No.: 13/487,882

(22) Filed: Jun. 4, 2012

(30) Foreign Application Priority Data
Jul. 19, 2011 (JP) 2011-158455

(51) Int. Cl. G06F 3/041

(52) U.S. Cl. 345/173

(57) ABSTRACT

An electronic apparatus comprises an operation unit; a plurality of touch detection units each configured to detect a touch input to the operation unit; a sensitivity adjustment unit configured to perform adjustment so that a sensitivity of a touch detection unit of the plurality of touch detection units, which is arranged on a far side with respect to a specific end portion of the electronic apparatus, becomes higher than a sensitivity of a touch detection unit of the plurality of touch detection units, which is arranged on a near side with respect to the specific end portion; and a determination unit configured to determine an operated portion of the operation unit based on output values from the plurality of touch detection units, which have been adjusted by the sensitivity adjustment unit.

### BACKGROUND OF THE INVENTION

1. Field of the Invention

The present invention relates to an electronic apparatus which has a touch sensor type operation member, and a control method therefor.

2. Description of the Related Art

Conventionally, an image capturing apparatus incorporates an operation member such as a cross key or a dial for selecting a setting item. In recent years, products incorporating a touch panel as a display device are spreading. Such a product enables the user to select/set a displayed setting item by only touching it. Furthermore, some products incorporate a touch sensor as an operation member. The use of such an operation member as a user interface with an image capturing apparatus in shooting a moving image is highly expected. The operation sound is unwantedly recorded as noise when the user makes settings with a conventional mechanical operation member during shooting a moving image. Using an operation member adopting a touch sensor, however, it is possible to cut down the recorded operation sound.

The touch panel or touch sensor includes a capacitance type, a resistance film type, and an optical type. These types have advantages and disadvantages, and have been widely used according to their application. Among them, the capacitance type can perform detection with high accuracy, and has been adopted by many devices. In Japanese Patent Laid-Open No. 2009-212719, a detection sensor for detecting that the user grips a grip portion and a detection sensor for detecting position information are included. There is disclosed a technique of amplifying, if an output value from the detection sensor for detecting that the user grips the grip portion is smaller than a predetermined threshold, for example, if the user wears a glove, an output value from the detection sensor for detecting position information.

To perform an operation while gripping a camera such as a single-lens reflex camera, however, it is necessary to provide measures against an unwanted operation for a plurality of sensors due to the arrangement of a touch sensor and measures against an erroneous operation due to the accessibility or inaccessibility of the sensor with a finger.

### SUMMARY OF THE INVENTION

The present invention has been made in consideration of the aforementioned problems, and realizes an electronic apparatus which can decrease the possibility of an erroneous operation for a touch sensor while gripping a grip portion.

In order to solve the aforementioned problems, the present invention provides an electronic apparatus comprising: an operation unit; a plurality of touch detection units each configured to detect a touch input to the operation unit; a sensitivity adjustment unit configured to perform adjustment so that a sensitivity of a touch detection unit of the plurality of touch detection units, which is arranged on a far side with respect to a specific end portion of the electronic apparatus, becomes higher than a sensitivity of a touch detection unit of the plurality of touch detection units, which is arranged on a near side with respect to the specific end portion; and a determination unit configured to determine an operated portion of the operation unit based on output values from the plurality of touch detection units, which have been adjusted by the sensitivity adjustment unit.

In order to solve the aforementioned problems, the present invention provides an electronic apparatus comprising: a plurality of operation units; a plurality of touch detection units configured to detect touch inputs to the plurality of operation units; a sensitivity adjustment unit configured to perform adjustment so that a sensitivity of a touch detection unit of the plurality of touch detection units, which is arranged on a far side with respect to a specific end portion of the electronic apparatus, becomes higher than a sensitivity of a touch detection unit of the plurality of touch detection units, which is arranged on a near side with respect to the specific end portion; and a determination unit configured to determine an operated operation unit of the plurality of operation units based on output values from the plurality of touch detection units, which have been adjusted by the sensitivity adjustment unit.

In order to solve the aforementioned problems, the present invention provides an electronic apparatus comprising: an operation unit; a plurality of touch detection units each configured to detect a touch input to the operation unit; a sensitivity adjustment unit configured to perform adjustment so that a sensitivity of a touch detection unit of the plurality of touch detection units, which is arranged on a far side with respect to a grip portion of the electronic apparatus, becomes higher than a sensitivity of a touch detection unit of the plurality of touch detection units, which is arranged on a near side with respect to the grip portion; and a determination unit configured to determine an operated portion of the operation unit based on output values from the plurality of touch detection units, which have been adjusted by the sensitivity adjustment unit.

In order to solve the aforementioned problems, the present invention provides an electronic apparatus comprising: a plurality of operation units; a plurality of touch detection units configured to detect touch inputs to the plurality of operation units; a sensitivity adjustment unit configured to perform adjustment so that a sensitivity of a touch detection unit of the plurality of touch detection units, which is arranged on a far side with respect to a grip portion of the electronic apparatus, becomes higher than a sensitivity of a touch detection unit of the plurality of touch detection units, which is arranged on a near side with respect to the grip portion; and a determination unit configured to determine an operated operation unit of the plurality of operation units based on output values from the plurality of touch detection units, which have been adjusted by the sensitivity adjustment unit.

In order to solve the aforementioned problems, the present invention provides a control method of an electronic apparatus which has an operation unit and a plurality of touch detection units each configured to detect a touch input to the operation unit, the method comprising: a sensitivity adjustment step of performing adjustment so that a sensitivity of a touch detection unit of the plurality of touch detection units, which is arranged on a far side with respect to a specific end portion of the electronic apparatus, becomes higher than a sensitivity of a touch detection unit of the plurality of touch detection units, which is arranged on a near side with respect to the specific end portion; and a determination step of determining an operated portion of the operation unit based on output values from the plurality of touch detection units, which have been adjusted in the sensitivity adjustment step.

In order to solve the aforementioned problems, the present invention provides a control method of an electronic apparatus which has a plurality of operation units and a plurality of touch detection units configured to detect touch inputs to the plurality of operation units, the method comprising: a sensitivity adjustment step of performing adjustment so that a sensitivity of a touch detection unit of the plurality of touch detection units, which is arranged on a far side with respect to a specific end portion of the electronic apparatus, becomes higher than a sensitivity of a touch detection unit of the plurality of touch detection units, which is arranged on a near side with respect to the specific end portion; and a determination step of determining an operated operation unit of the plurality of operation units based on output values from the plurality of touch detection units, which have been adjusted in the sensitivity adjustment step.

In order to solve the aforementioned problems, the present invention provides a control method of an electronic apparatus which has an operation unit and a plurality of touch detection units each configured to detect a touch input to the operation unit, the method comprising: a sensitivity adjustment step of performing adjustment so that a sensitivity of a touch detection unit of the plurality of touch detection units, which is arranged on a far side with respect to a grip portion of the electronic apparatus, becomes higher than a sensitivity of a touch detection unit of the plurality of touch detection units, which is arranged on a near side with respect to the grip portion; and a determination step of determining an operated portion of the operation unit based on output values from the plurality of touch detection units, which have been adjusted in the sensitivity adjustment step.

In order to solve the aforementioned problems, the present invention provides a control method of an electronic apparatus which has a plurality of operation units and a plurality of touch detection units configured to detect touch inputs to the plurality of operation units, the method comprising: a sensitivity adjustment step of performing adjustment so that a sensitivity of a touch detection unit of the plurality of touch detection units, which is arranged on a far side with respect to a grip portion of the electronic apparatus, becomes higher than a sensitivity of a touch detection unit of the plurality of touch detection units, which is arranged on a near side with respect to the grip portion; and a determination step of determining an operated operation unit of the plurality of operation units based on output values from the plurality of touch detection units, which have been adjusted in the sensitivity adjustment step.

According to the present invention, it is possible to decrease the possibility of an erroneous operation for a touch sensor while gripping a grip portion.

Further features of the present invention will become apparent from the following description of exemplary embodiments (with reference to the attached drawings).

### BRIEF DESCRIPTION OF THE DRAWINGS

FIG. 1 is a block diagram showing an image capturing apparatus according to an embodiment of the present invention;

FIGS. 2A to 2C are views each showing the outer appearance of the image capturing apparatus according to the embodiment;

FIGS. 3A1 to 3A3, 3B1 to 3B3, 3C1 to 3C3, and 3D1 to 3D3 are views for explaining a touch sensor operation and a detection sensitivity adjustment method while gripping a grip portion;

FIGS. 4A and 4B are flowcharts illustrating a touch sensor operation and detection sensitivity adjustment processing while gripping the grip portion;

FIGS. 5A1 to 5A3, 5B1 to 5B3, and 5C1 to 5C3 are views for explaining a touch sensor operation and a detection sensitivity adjustment method when the user touches a plurality of electrodes at once;

FIGS. 6A and 6B are views each for explaining a case in which a plurality of electrodes are classified into groups; and

FIGS. 7A1, 7A2, 7B1, 7B2, 7C1, 7C2, 7D1, and 7D2 are views for explaining a case in which a detection threshold for a touch sensor operation is changed for each electrode.

### DESCRIPTION OF THE EMBODIMENTS

Embodiments of the present invention will be described in detail below.

### <Apparatus Configuration>

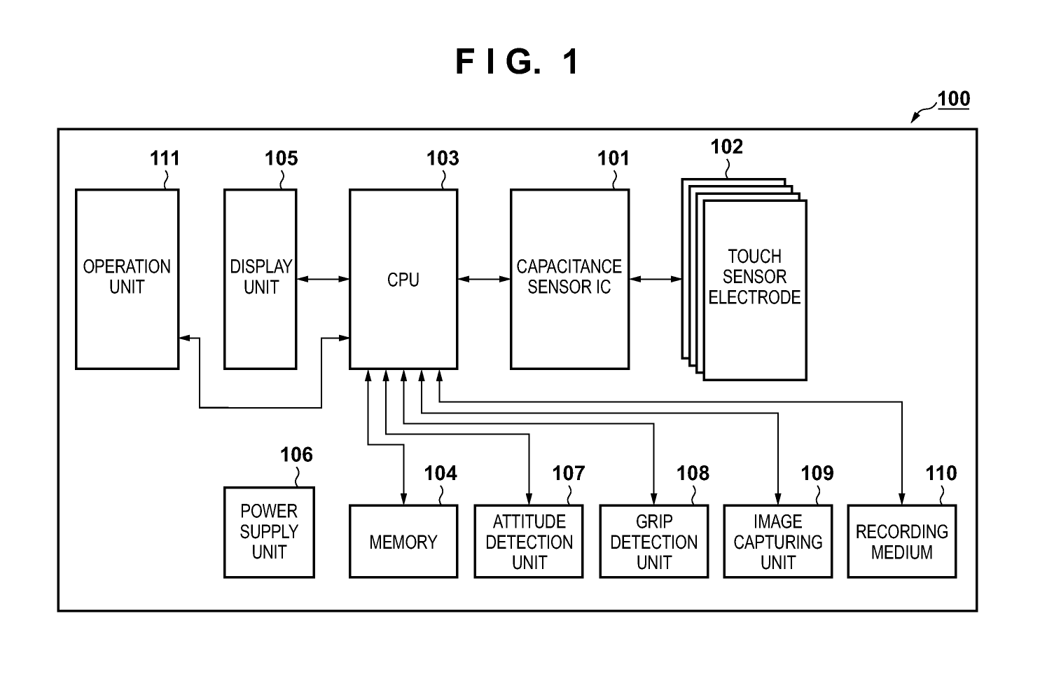

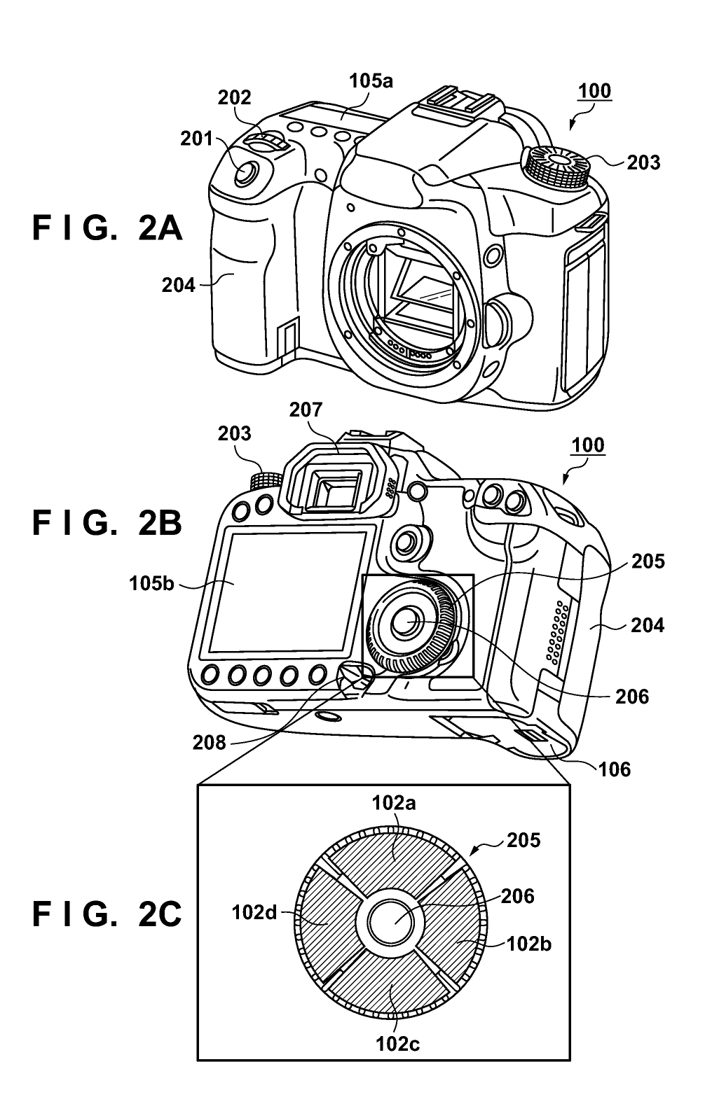

The function and outer appearance of an image capturing apparatus (a lens-interchangeable single-lens reflex camera will be exemplified in an embodiment) according to the embodiment to which an electronic apparatus according to the present invention is applied will be described with reference to FIGS. 1 and 2A to 2C. Note that the present invention is not limited to the image capturing apparatus, and is also applicable to various apparatuses which can be operated while gripping a grip portion.

Referring to FIG. 1, an image capturing apparatus (to be referred to as a camera hereinafter) 100 includes, as main components, a CPU 103, a capacitance sensor IC 101, touch sensor electrodes 102, a display unit 105, a memory 104, a power supply unit 106, an attitude detection unit 107, and a grip detection unit 108. Although the CPU 103 and the capacitance sensor IC 101 are shown as separate components in FIG. 1, the CPU 103 may incorporate the capacitance sensor IC.

Each touch sensor electrode (to be simply referred to as an electrode hereinafter) 102 detects a touch or the proximity of a user's finger, and is formed by an electric conductor such as the copper foil pattern of a board. Although the four touch sensor electrodes are shown in FIG. 1 for descriptive convenience, the present invention is not limited to this, and the camera may include a plurality of touch sensor electrodes.

The capacitance sensor IC (to be referred to as a sensor IC hereinafter) 101 detects a changing capacitance value of the touch sensor electrode 102. The capacitance of the touch sensor electrode 102 changes when the user's finger touches or comes close to the electrode. The sensor IC 101 can regularly monitor a change in capacitance of the touch sensor electrode 102. Furthermore, a threshold can be set in the sensor IC 101. If a change in capacitance is equal to or larger than the predetermined threshold, the sensor IC 101 can notify the CPU 103 of an interruption. Upon receiving the interruption notification from the sensor IC 101, the CPU 103 executes reading processing for the sensor IC 101. Based on the result of the reading processing, the CPU 103 can detect an electrode the capacitance of which has changed, and then determines an operation direction. Note that the function of generating an interruption notification based on the set threshold is not essential and the sensor IC 101 need only regularly monitor a change in capacitance. As described above, the CPU 103 may have the function of the sensor IC 101.

The CPU 103 updates information on the display unit 105 according to the detection results of the touch sensor electrodes 102.

Furthermore, the CPU 103 controls the operation of the camera. The CPU 103 maps a program recorded in the memory 104 on a work area of a nonvolatile memory such as a RAM, and executes the program, thereby performing the various processes of a flowchart (to be described later).

The display unit 105 includes a TFT and LCD and, for example, displays the operation status of the camera.

The memory 104 includes a nonvolatile memory or volatile memory, and is used to store programs such as determination processing (to be described later) and to temporarily store the status of the camera.

The power supply unit 106 is a power supply for driving the camera. Although arrows are omitted in FIG. 1, the power supply unit 106 supplies power to each block which requires power supply.

The attitude detection unit 107 is used to detect the attitude of the camera, and can detect whether the user holds the camera in a normal position or a vertical position. The attitude detection unit 107 includes, for example, an acceleration sensor and portrait/landscape detection sensor.

The grip detection unit 108 is used to detect whether the user grips the camera when holding it. By providing a plurality of grip portions, it becomes possible to detect a position where the user grips the camera. The grip detection unit 108 includes, for example, a photo interrupter and touch sensors.

An image capturing unit 109 includes an image sensor such as a CCD or CMOS sensor, a shooting lens, an aperture stop, and a shutter curtain. The unit 109 photo-electrically converts an object image into an electric signal, and captures it.

A recording medium 110 includes a semiconductor memory card for recording captured image data, and is detachable from the camera. Note that the recording medium 110 may be an internal memory.

An operation unit 111 includes various operation members as an input unit for receiving a user operation. As shown in FIGS. 2A to 2C, the operation unit 111 includes at least a release button 201, a main electronic dial 202, a mode dial 203, a sub electronic dial 205, a set button 206, and a power switch 208.

FIG. 2A is a view showing the outer appearance of the camera of the embodiment when seen from the front side. FIG. 2B is a view showing the outer appearance of the camera when seen from the back side. FIG. 2C is an enlarged view showing the internal arrangement of the sub electronic dial. In this embodiment, a case in which the touch sensor electrodes 102 are arranged in the sub electronic dial will be described. The same reference numerals denote the same parts as those in FIG. 1. A portion where the touch sensor electrodes 102 are arranged is not limited to the sub electronic dial.

As shown in FIGS. 2A and 2B, the release button 201 is an operation member for providing a shooting preparation instruction and a shooting instruction. When the user presses this button halfway, the luminance of an object is measured and focusing is performed. When the user fully presses this button, the shutter is released to shoot an image.

The main electronic dial 202 is a turning operation member. The user turns the main electronic dial 202 to set setting values such as a shutter speed and aperture value, and to perform fine adjustment of a zoom magnification in a zoom mode.

The sub electronic dial 205 is a turning operation member. The user turns the sub electronic dial 205 to set setting values such as an aperture value and exposure correction, and to perform an operation of forwarding one frame in an image display state.

The set button 206 is an operation member for determining an item or setting value selected with the main electronic dial 202 or sub electronic dial 205.

The mode dial 203 is a turning operation member, which is used by the user to select the operation mode of the camera such as a playback mode or shooting mode.

A grip portion 204 is a portion which the user grips to hold the camera in shooting. The grip portion 204 has a structure which makes it easy to operate the camera to make its settings or to view images while gripping the grip portion 204.

A display unit 105a includes, for example, an LCD and TFT. The display unit 105a is used to display setting information of the camera or the like, and displays a camera mode, an ISO sensitivity setting, a shutter speed, an aperture value, a white balance setting, a focus setting, a drive mode setting, the number of recordable images, a remaining battery level, and the like.

A display unit 105b includes, for example, a TFT. In addition to the setting information displayable on the display unit 105a, the display unit 105b can display a menu, a shot image/moving image, a live-view image, and the like.

A finder 207 includes an optical finder, an electronic view finder, or the like. The user can check an object, the composition, an in-focus position, the settings of the camera, and the like through the finder 207.

The power switch 208 is an operation member for powering on and off the camera.

A battery, a DC coupler, or the like is inserted into the power supply unit 106, which converts a voltage into a desired one through a regulator or DC-DC converter, and then supplies power to each block.

As shown in FIG. 2C, touch sensor electrodes 102a, 102b, 102c, and 102d are arranged within the sub electronic dial 205. Each electrode includes the copper foil wiring of a printed circuit board, and incorporates a printed circuit board having an electrode shape as shown in FIG. 2C. Although the number of electrodes is four in FIG. 2C, the present invention is not limited to this. Furthermore, the electrode shape is not limited to a sector shown in FIG. 2C.

The user can, for example, select a setting value on the display unit 105a or 105b by touching each electrode. The touch sensor electrodes 102a, 102b, 102c, and 102d correspond to the upper, right, lower, and left direction keys of a cross key, respectively, and can be operated. For example, when the user wants to move, upward, a cursor displayed on the display unit 105b, he/she can move the cursor by touching the electrode 102a.

Using touch sensors as an operation member can cut down the operation sound which is unwantedly recorded together with the audio of a moving image when changing a setting item while shooting the moving image. If the recording level is adjusted by making settings with the main electronic dial 202 or sub electronic dial 205, an indicator for the recording level may unwantedly change according to the operation sound. Using touch sensors, however, enables to display a correct indicator for the recording level.

The user often sets shooting conditions and the like for the camera while gripping the grip portion 204 in shooting. Furthermore, the user often operates a menu while gripping the grip portion 204. At this time, the user often operates the touch sensor with the thumb of the hand which grips the grip portion 204. While gripping the grip portion 204, the accessibility of each touch sensor changes depending on its distance from the grip position or the shape of the operation member (the surface of the sub electronic dial or the touch sensor electrode). For example, the electrode 102b may be easy to touch but the electrode 102d may be difficult to touch. When the user touches the electrode 102d, the ball of the thumb may overlap the electrode 102c or the like because the user grips the grip portion 204, and a large capacitance of the electrode 102c may be output depending on the way the electrode is pressed, thereby causing an erroneous operation.

To deal with this problem, in terms of whether each electrode is easy to touch, depending on the distance from the grip position and the shape of the operation member (the surface of the sub electronic dial or the touch sensor electrode), the sensitivity of an electrode which is difficult to touch is set to be relatively high. More specifically, the sensitivity of an electrode which is difficult to touch is set to be relatively high by multiplying a capacitance value detected in each electrode by a predetermined value.

### <Touch Sensor Operation and Detection Sensitivity Adjustment>

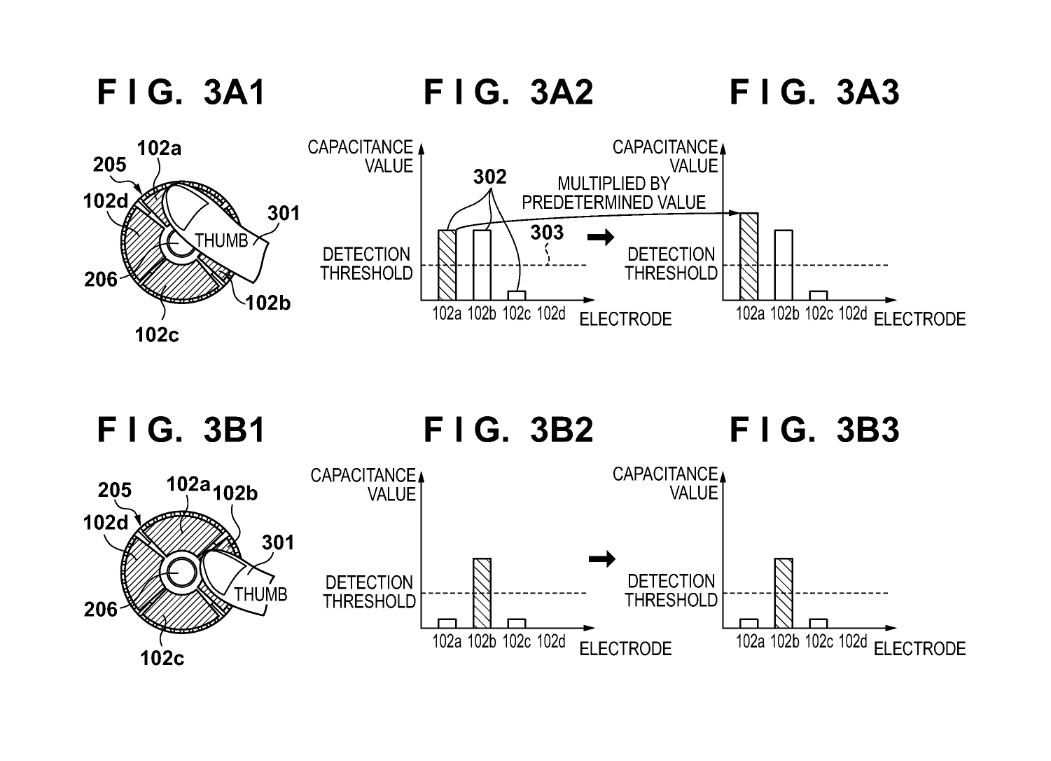

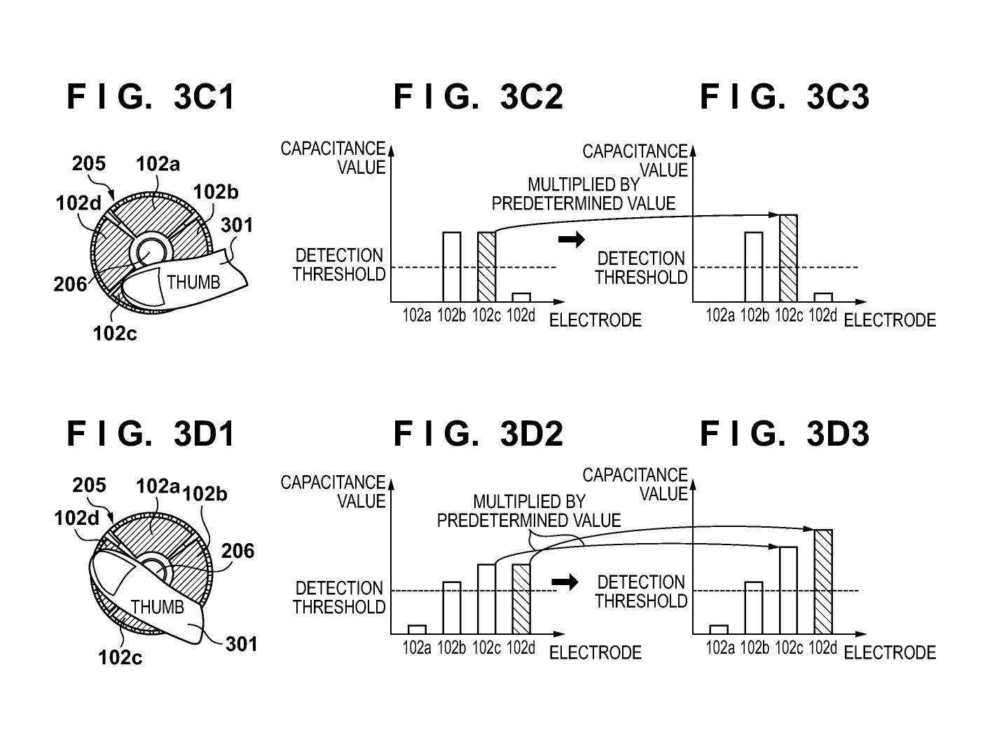

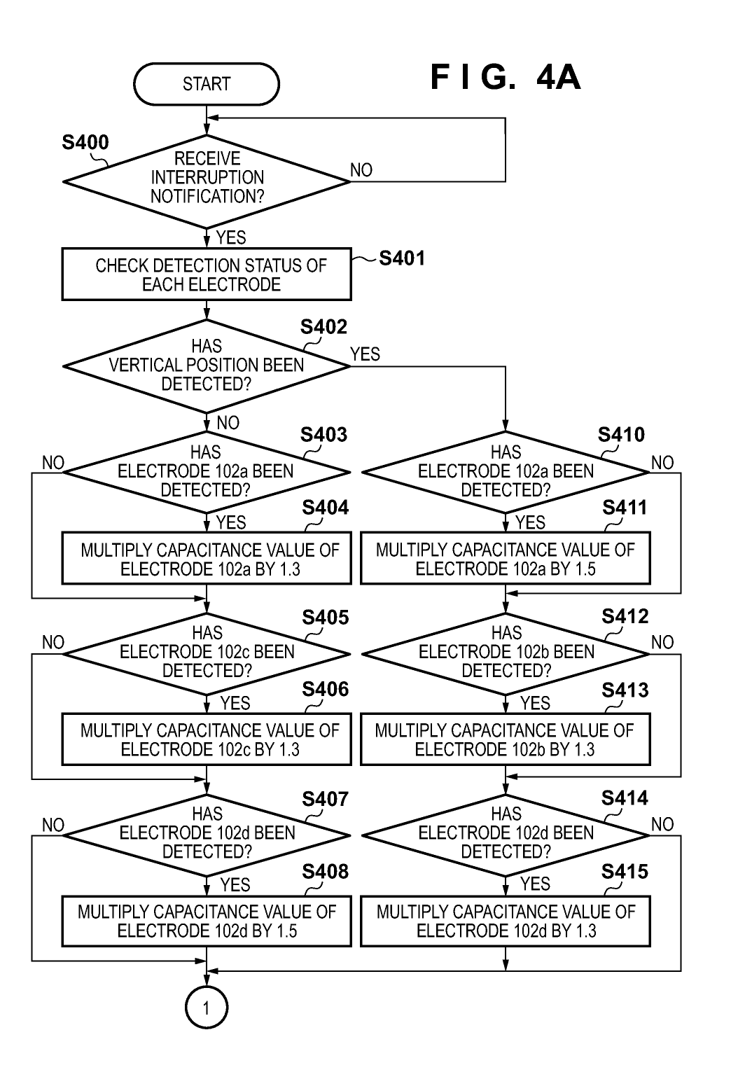

A case in which a capacitance value changes when the user touches each electrode while gripping the camera and a correction method of multiplying the capacitance value of each electrode which is difficult to touch by a predetermined value will be described with reference to FIGS. 3A1 to 3A3, 3B1 to 3B3, 3C1 to 3C3, and 3D1 to 3D3. FIGS. 3A1, 3B1, 3C1, and 3D1 are schematic views each showing a case in which the user touches each electrode with a thumb 301. FIGS. 3A2, 3B2, 3C2, and 3D2 are graphs each showing an example of a capacitance value 302 detected in each electrode. FIGS. 3A3, 3B3, 3C3, and 3D3 are graphs each showing an example of a capacitance value obtained by multiplying a capacitance value detected in each electrode by a predetermined value.

When the sensor IC 101 detects a capacitance value exceeding a detection threshold 303, it notifies the CPU 103 of an interruption. Upon receiving the interruption notification, the CPU 103 can detect that a user's finger touches or comes close to a corresponding electrode. After that, the CPU 103 communicates with the sensor IC 101 to obtain the capacitance value 302 of each electrode, thereby determining a touch position. Before determining the touch position, the CPU 103 multiplies the capacitance value of each electrode by a predetermined value. Note that the present invention is not limited to this if the CPU 103 includes the function of the sensor IC 101. Although a case in which the CPU 103 relatively amplifies the capacitance value of a given electrode to determine a touch position will be described with reference to FIGS. 3A1 to 3A3, 3B1 to 3B3, 3C1 to 3C3, and 3D1 to 3D3, the sensor IC 101 may multiply the capacitance value of each electrode by a predetermined value by setting, in the sensor IC 101, an electrode the capacitance value of which is to be relatively amplified.

FIG. 3A1 is a view for explaining a case in which the user touches the electrode 102a, that is, the upper direction key. If the user tries to touch the electrode 102a with the thumb 301 while gripping the grip portion 204, the ball of the thumb 301 may come close to the electrode 102b. In this case, although the user has intended to press the upper direction key, an operation in the right direction may be performed depending on the way the key is touched. The capacitance values detected in the respective electrodes are as shown in FIG. 3A2 at this time, in which the capacitance value of the electrode 102a which the user intentionally touches may be almost equal to that of the electrode 102b which the user unintentionally touches. To deal with this problem, as shown in FIG. 3A3, the CPU 103 multiplies the capacitance value obtained in the electrode 102a by a predetermined value (1.3 in this embodiment), thereby setting the capacitance value obtained in the electrode 102a to be relatively larger than that obtained in the electrode 102b. Consequently, an operation in the direction intended by the user is performed.

FIG. 3B1 is a view for explaining a case in which the user touches the electrode 102b, that is, the right direction key. When the user touches the electrode 102b, the capacitance values obtained in the respective electrodes are considered to have an almost ideal distribution even if the user grips the grip portion 204 (FIG. 3B2). This is because the user can ideally touch the electrode 102b with the finger without overlapping other electrodes even if he/she grips the grip portion 204. Therefore, the capacitance value of the electrode 102b is used intact to determine an operation direction.

FIG. 3C1 is a view for explaining a case in which the user touches the electrode 102c, that is, the lower direction key. As in a case in which the user touches the electrode 102a, if the user tries to touch the electrode 102c with the thumb 301 while gripping the grip portion 204, the ball of the thumb 301 may come close to the electrode 102b. In this case, even though the user has intended to press the lower direction key, an operation in the right direction may be performed depending on the way the key is touched. The capacitance values detected in the respective electrodes are as shown in FIG. 3C2 at this time, in which the capacitance value of the electrode 102c which the user intentionally touches may be almost equal to that of the electrode 102b which the user unintentionally touches. To deal with this problem, as shown in FIG. 3C3, the CPU 103 multiplies the capacitance value obtained in the electrode 102c by a predetermined value (1.3 in this embodiment), thereby setting the capacitance value obtained in the electrode 102c to be relatively larger than that obtained in the electrode 102b. Consequently, an operation in the direction intended by the user is performed.

FIG. 3D1 is a view for explaining a case in which the user touches the electrode 102d, that is, the left direction key. When the user tries to touch the electrode 102d with the thumb 301 while gripping the grip portion 204, the ball of the thumb 301 may come close to the electrode 102c or 102b. In this case, even though the user has intended to press the left direction key, an operation in the lower or right direction may be performed depending on the way the key is touched. The capacitance values detected in the respective electrodes are as shown in FIG. 3D2 at this time, in which the capacitance value of the electrode 102d which the user intentionally touches may be almost equal to that of the electrode 102c which the user unintentionally touches. To deal with this problem, as shown in FIG. 3D3, the CPU 103 multiplies the capacitance value obtained in the electrode 102d by a predetermined value (1.5 in this embodiment), thereby setting the capacitance value obtained in the electrode 102d to be relatively larger than that obtained in the electrode 102c. Note that the capacitance value of the electrode 102c is also unwantedly multiplied by the predetermined value in the case shown in FIG. 3D3, as described with reference to FIG. 3C3. To deal with this problem, the amplification factor of the electrode 102d which is larger than that of the electrode 102c or 102a is used to perform an operation in the direction intended by the user, that is, the left direction.

In FIGS. 3A1 to 3A3, 3B1 to 3B3, 3C1 to 3C3, and 3D1 to 3D3, in terms of the accessibilities of the electrodes, the electrode 102d is classified as an electrode with a lowest accessibility, the electrodes 102a and 102c are classified as electrodes with a second lowest accessibility, and the electrode 102b is classified as an electrode with a highest accessibility. Based on this classification, an amplification factor used to amplify an obtained capacitance value is set to, for example, 1.5 for the electrode 102d, 1.3 for the electrodes 102a and 102c, and 1.0 for the electrode 102b.

Since, however, the accessibility of a touch sensor electrode changes depending on its arrangement with respect to the grip position, and an outer structure which the finger touches, it is necessary to change a method of correcting a capacitance value as needed. The correction method is not limited to the relationship between the amplification factors, and needs to be tuned as needed.

The user may shoot an image while holding the camera in not only the normal position but also the vertical position. Many cameras have a grip portion for the vertical position. In such a camera, when the vertical position is detected, the classification of the electrodes by the sensitivities may be changed. The attitude detection unit 107, that is, the acceleration sensor and portrait/landscape detection sensor detect that the user holds the camera in the vertical position. Furthermore, providing a detection unit for detecting that the user grips the grip portion enables to correctly identify a grip position, thereby achieving a touch sensor operation almost without causing an erroneous operation independent of the grip position.

### <Description of Operation>

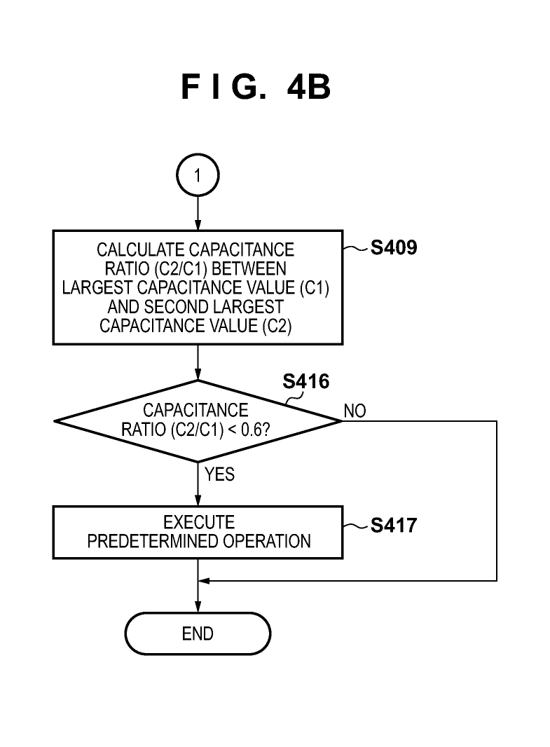

A touch sensor operation and detection sensitivity adjustment processing will be described with reference to FIGS. 4A and 4B. Processings in FIGS. 4A and 4B are implemented when the CPU 103 maps a program recorded in the memory 104 on a work area of a nonvolatile memory such as a RAM, and executes the program. Note that although the processing is assumed to be executed by the CPU 103 in this example, it may be executed by the sensor IC 101.

Referring to FIG. 4A, in step S400, the CPU 103 stands by for an interruption notification from the sensor IC 101. The sensor IC 101 outputs an interruption notification to the CPU 103 when a detected capacitance value becomes larger or smaller than a predetermined threshold. Note that although FIGS. 4A and 4B show a case in which an interruption notification output from the sensor IC 101 is used, the CPU 103 may monitor the timing when the capacitance value becomes larger or smaller than the predetermined value by regularly monitoring the capacitance value.

In step S401, the CPU 103 checks the detection status of each electrode, and obtains the capacitance value of each electrode, thereby determining an electrode, the capacitance value of which is larger (smaller) than the detection threshold 303 (to be simply referred to as a threshold hereinafter).

In step S402, the CPU 103 detects the attitude of the camera 100 based on information from the attitude detection unit 107. If the user holds the camera in the vertical position, the process advances to step S410. If the user holds camera in the normal position, the process advances to step S403. Note that in FIG. 4A, when the normal position is assumed to be 0°, the vertical position is obtained by rotating the camera counterclockwise about the optical axis by 90°. In the normal position, as described above, in terms of the accessibilities of the electrodes, the electrode 102d is classified as an electrode with a lowest accessibility, the electrodes 102a and 102c are classified as electrodes with a second lowest accessibility, and the electrode 102b is classified as an electrode with a highest accessibility. On the other hand, in the vertical position obtained by rotating the camera counterclockwise by 90°, in terms of the accessibilities of the electrodes, the electrode 102a is classified as an electrode with a lowest accessibility, the electrodes 102b and 102d are classified as electrodes with a second lowest accessibility, and the electrode 102c is classified as an electrode with a highest accessibility.

In step S403, the CPU 103 determines whether the capacitance value of the electrode 102a exceeds the threshold. If the capacitance value of the electrode 102a exceeds the threshold, the capacitance value obtained in step S401 is multiplied by 1.3 (step S404). Note that although the amplification factor of the electrode 102a is 1.3 in this example, the present invention is not limited to this.

In step S405, the CPU 103 determines whether the capacitance value of the electrode 102c exceeds the threshold. If the capacitance value of the electrode 102c exceeds the threshold, the capacitance value obtained in step S401 is multiplied by 1.3 (step S406). Note that although the amplification factor of the electrode 102c is 1.3 in this example, the present invention is not limited to this.

In step S407, the CPU 103 determines whether the capacitance value of the electrode 102d exceeds the threshold. If the capacitance value of the electrode 102d exceeds the threshold, the capacitance value obtained in step S401 is multiplied by 1.5 (step S408). Note that although the amplification factor of the electrode 102d is 1.5 in this example, the present invention is not limited to this. The amplification factor of the electrode 102d is set to be larger than that of the electrode 102a or 102c. This is because, as described with reference to FIGS. 3A1 to 3A3, 3B1 to 3B3, 3C1 to 3C3, and 3D1 to 3D3, when the user touches the electrode 102d, the finger may also overlap the electrode 102c. Therefore, different amplification factors are used to reliably identify the electrode 102d.

Note that since the electrode 102b is arranged at a position where it is easy to touch, the capacitance value obtained in step S401 is used intact.

In step S410, the CPU 103 determines whether the capacitance value of the electrode 102a exceeds the threshold. If the capacitance value of the electrode 102a exceeds the threshold, the capacitance value obtained in step S401 is multiplied by 1.5 (step S411). Note that although the amplification factor of the electrode 102a is 1.5 in this example, the present invention is not limited to this. Similarly to step S408, since the electrode 102a is arranged at a position where it is difficult to touch as compared with the other electrodes when the user holds the camera in the vertical position, the amplification factor of the electrode 102a is set to be larger than those of the other electrodes.

In step S412, the CPU 103 determines whether the capacitance value of the electrode 102b exceeds the threshold. If the capacitance value of the electrode 102b exceeds the threshold, the capacitance value obtained in step S401 is multiplied by 1.3 (step S413). Note that although the amplification factor of the electrode 102b is 1.3 in this example, the present invention is not limited to this.

In step S414, the CPU 103 determines whether the capacitance value of the electrode 102d exceeds the threshold. If the capacitance value of the electrode 102d exceeds the threshold, the capacitance value obtained in step S401 is multiplied by 1.5 (step S415). Note that although the amplification factor of the electrode 102d is 1.5 in this example, the present invention is not limited to this.

Since the electrode 102c is arranged at a position where it is easy to touch when the user holds the camera in the vertical position, the capacitance value obtained in step S401 is used intact.

Referring to FIG. 4B, in step S409, the CPU 103 calculates the largest capacitance value (represented by C1) and the second largest capacitance value (represented by C2) among the capacitance values of the electrodes, and also calculates the capacitance ratio (C2/C1) between them. In step S409, if there is a value corrected by performing amplification using a predetermined value, the CPU 103 performs calculation using the corrected capacitance value. As the capacitance ratio is close to 1, this indicates that the user touches two electrodes. As the capacitance ratio is smaller (close to 0), this indicates that the user accurately touches one electrode.

In step S416, the CPU 103 determines whether the capacitance ratio (C2/C1) calculated in step S409 is less than 0.6. If the capacitance ratio is less than 0.6, it is determined that the user accurately touches one electrode to some extent, and the process advances to step S417 to execute a predetermined operation. On the other hand, if the capacitance ratio is equal to or more than 0.6, the user may touch two or more electrodes and an erroneous operation in a direction different from that intended by the user may be performed and, therefore, the process ends without advancing to step S417. At this time, to indicate that the operation has not been received, an alarm may be generated or a warning may be displayed. Note that the processing in step S416 can be omitted as needed. Furthermore, the comparison value in step S416 is not limited to 0.6, and it is possible to change, as needed, the value so that it is possible to perform an operation without any stress while decreasing the possibility of an erroneous operation.

Note that in FIGS. 4A and 4B, when the capacitance value of each electrode exceeds the threshold, it is corrected. When, however, the capacitance value of at least one electrode exceeds the threshold, the capacitance value of each electrode may be corrected.

Furthermore, when it is detected as the detection result of the grip detection unit 108 that the user grips the camera, the processings in FIGS. 4A and 4B may be executed; otherwise, the capacitance values of the respective electrodes may be compared with each other without correction. With this processing, there is no need to perform unwanted correction, when the user does not grip the camera, for example, when the user performs a touch sensor operation with the index finger of the hand which does not hold the camera.

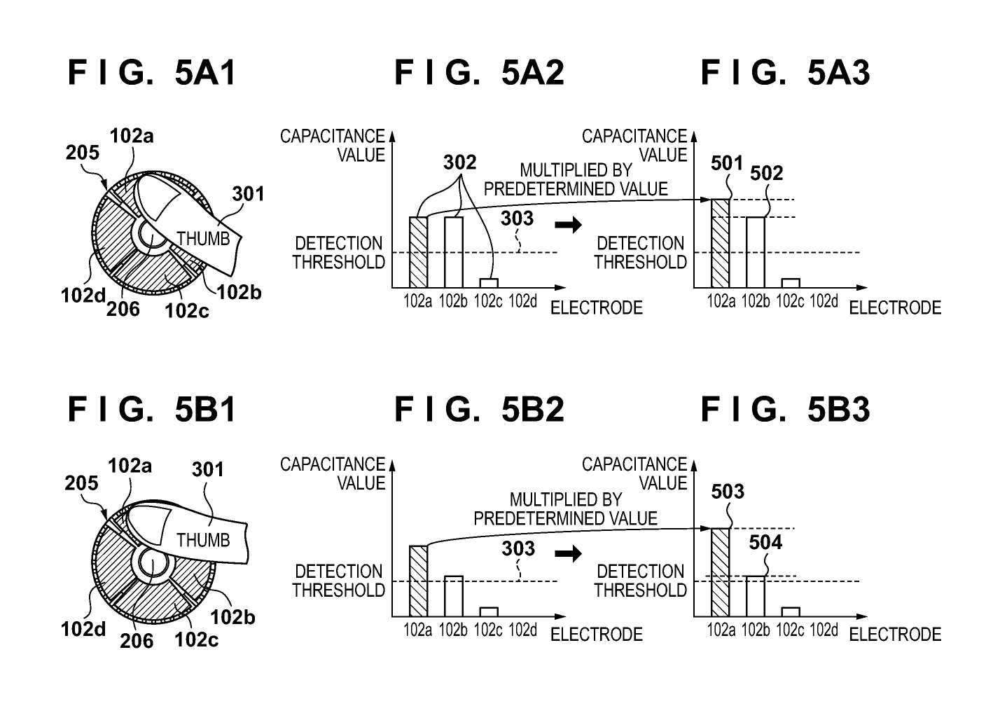

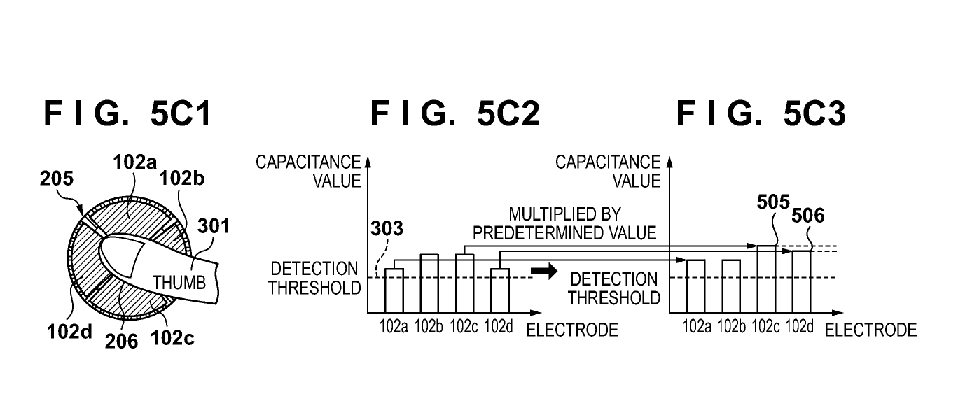

Measures against an erroneous operation when the user touches two or more electrodes, which have been described in step S416 of FIG. 4B, will be described in more detail with reference to FIGS. 5A1 to 5A3, 5B1 to 5B3, and 5C1 to 5C3.

FIG. 5A1 is a schematic view showing a case in which the user touches the electrodes 102a and 102b with the thumb 301. FIG. 5A2 shows an example of the capacitance value 302 detected in each electrode at this time. FIG. 5A3 shows an example of a capacitance value obtained by multiplying the capacitance value detected in each electrode by a predetermined value. As shown in FIG. 5A3, the capacitance ratio (C2/C1) between the largest capacitance value (the capacitance value C1 of the electrode 102a) and the second largest capacitance value (the capacitance value C2 of the electrode 102b) among the capacitance values multiplied by predetermined values, which is more than 0.6, is calculated (practical numerical values are omitted). In this case, it is determined that the finger of the user touches two electrodes, and then a touch input is determined to be invalid.

FIG. 5B1 is a schematic view showing a case in which the user intentionally touches the electrode 102a with the thumb 301. FIG. 5B2 shows an example of a capacitance value detected in each electrode at this time. FIG. 5B3 shows an example of a capacitance value obtained by multiplying the capacitance value detected in each electrode by a predetermined value. Unlike the case shown in FIG. 5A3, the capacitance ratio is equal to or less than 0.6 (practical numerical values are omitted) and, therefore, it is recognized that the user has touched the electrode 102a. This processing enables to perform an operation in a direction desired by the user without any erroneous operation when the user intentionally touches a predetermined electrode.

FIG. 5C1 is a schematic view showing a case in which the user presses the set button 206. FIG. 5C2 shows an example of a capacitance value detected in each electrode at this time. FIG. 5C3 shows an example of a capacitance value obtained by multiplying the capacitance value detected in each electrode by a predetermined value. When the user presses the set button 206, the capacitance values of the electrodes 102b and 102c may be detected to be slightly larger than those of the other electrodes as shown in FIG. 5C2, which, however, depends on the way the set button 206 is pressed. In this case, if the capacitance value of each electrode is multiplied by a predetermined value according to the above-described method, it is as shown in FIG. 5C3. As in the case shown in FIG. 5A3, the capacitance ratio between the largest capacitance value and the second largest capacitance value is equal to or more than 0.6, and therefore, the operation is controlled not to be performed. When, therefore, the user presses the set button 206, processing corresponding to the set button 206 is executed without any erroneous operation in a direction different from that intended by the user.

To shoot an image using the camera, the user looks through the finder 207. The user's face, therefore, may be in contact with the touch sensor (sub electronic dial 205). Furthermore, while the camera is carried, the hand or body may come into contact with the touch sensor unit. In this case, as in the case in which the set button 206 is pressed, the capacitance ratio is equal to or more than 0.6, thereby decreasing the possibility of an erroneous operation. It is assumed that, for example, if the face is in contact with the touch sensor, the capacitance values of all the four electrodes are equally detected. Consider corrected capacitance values. In this case, the capacitance value of the electrode 102d is obtained by multiplying the capacitance value of the electrode 102b by 1.5, and the capacitance values of the electrodes 102a and 102c are obtained by multiplying the capacitance value of the electrode 102b by 1.3. The capacitance value of the electrode 102d is largest, and the capacitance value of the electrode 102a or 102c is second largest. The ratio between the capacitance values is about 0.86 (=1.3/1.5). By setting the comparison value used in step S416 to 0.86, it is possible to prevent an erroneous operation as much as possible when the face or part of the body comes into contact with the touch sensor.

The above-described processing enables to prevent, as much as possible, unwanted operation such as simultaneous pressing of a plurality of arranged touch sensors, or an erroneous operation due to poor accessibility of the touch sensor with a finger, even when the user grips the camera such as a single-lens reflex camera.

### Second Embodiment

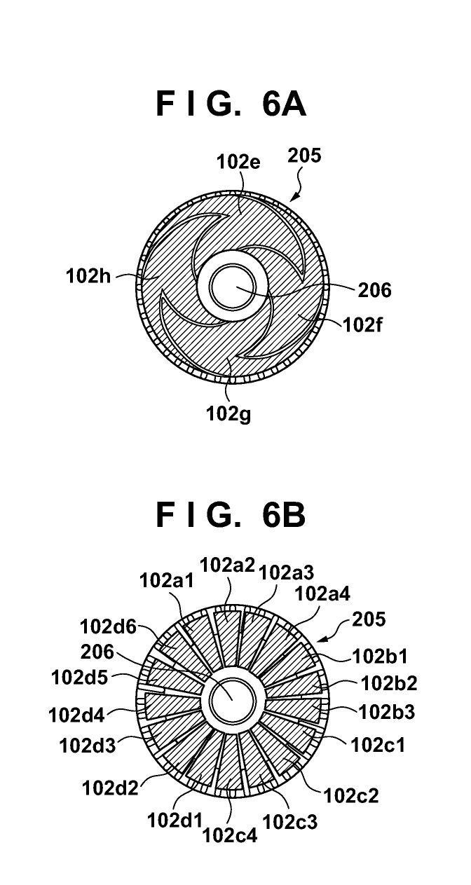

The second embodiment will be described with reference to FIGS. 6A and 6B.

FIG. 6A is a view showing touch sensor electrodes arranged in a sub electronic dial 205, similarly to FIG. 2C. A unit for digitally detecting the position of a touched electrode using the detection threshold 303 has been described with reference to FIGS. 3A1 to 3A3, 3B1 to 3B3, 3C1 to 3C3, and 3D1 to 3D3. FIG. 6A shows a case in which a capacitance value obtained when the user touches a corresponding electrode is detected in an analog manner and thus a touch position is determined.

Using the shape of a touch sensor electrode (102e, 102f, 102g, or 102h) shown in FIG. 6A, it is possible to more finely detect a position on the circumference of the dial where the user's finger is placed. When using the electrodes having such shape as upper, right, lower, and left direction operation keys, an operation region is divided into, for example, an upper region of 315° to 45° in the circumferential direction, a right region of 45° to 135°, a lower region of 135° to 225°, and a left region of 225° to 315°. As described above, when the user operates a touch sensor while gripping a grip portion 204, a certain region is easy to touch but another region is difficult to touch. To solve the problem that it is difficult to touch, a region which is difficult to touch while gripping the grip portion is widened. On the other hand, a region which is easy to touch is made smaller correspondingly, thereby uniforming the accessibilities of the electrodes. This makes it possible to suppress, as much as possible, the possibility of an erroneous operation due to the inaccessibility.

Furthermore, the user may shoot an image while holding the camera in the vertical position. If an attitude detection unit 107 detects the vertical position, it is possible to solve the problem that it is difficult to touch an electrode by changing the upper, right, lower, and left regions. Although a description will be omitted in FIGS. 6A and 6B, it is possible to further suppress the possibility of an erroneous operation by adding the processing in step S409 of FIG. 4B.

FIG. 6B shows another shape of a touch sensor electrode (electrodes 102a1 to 102a4, 102b1 to 102b3, 102c1 to 102c4, and 102d1 to 102d6). FIG. 6B shows a case in which the touch sensor electrodes are subdivided into electrodes to be arranged. When the user touches one of the electrodes 102a1 to 102a4 while holding the camera in the normal position, the upper direction is recognized. Alternatively, if the sum of the capacitance values of the electrodes 102a1 to 102a4 exceeds a detection threshold, the upper direction is recognized. Note that the number of electrodes corresponding to the left direction is larger than that of the electrodes corresponding to any other direction, and the number of electrodes corresponding to the upper or lower direction is larger than that of electrode corresponding to the right direction. By assigning different numbers of electrodes to the respective directions, a region which is difficult to touch is widened. It is also possible to suppress, as much as possible, the possibility of an erroneous operation due to the inaccessibility using the above method.

Furthermore, the user may shoot an image while holding the camera in the vertical position. When the attitude detection unit 107 detects the vertical position, it is possible to solve the problem that it is difficult to touch by changing the numbers of electrodes assigned to the upper, right, lower, and left directions. Although a description will be omitted in FIGS. 6A and 6B, it is possible to further suppress the possibility of an erroneous operation by adding the processing in step S409 of FIG. 4B.

According to this embodiment, it is possible to prevent, as much as possible, taking unwanted operation measures or performing an erroneous operation due to the accessibility or inaccessibility, as in the first embodiment.

### Third Embodiment

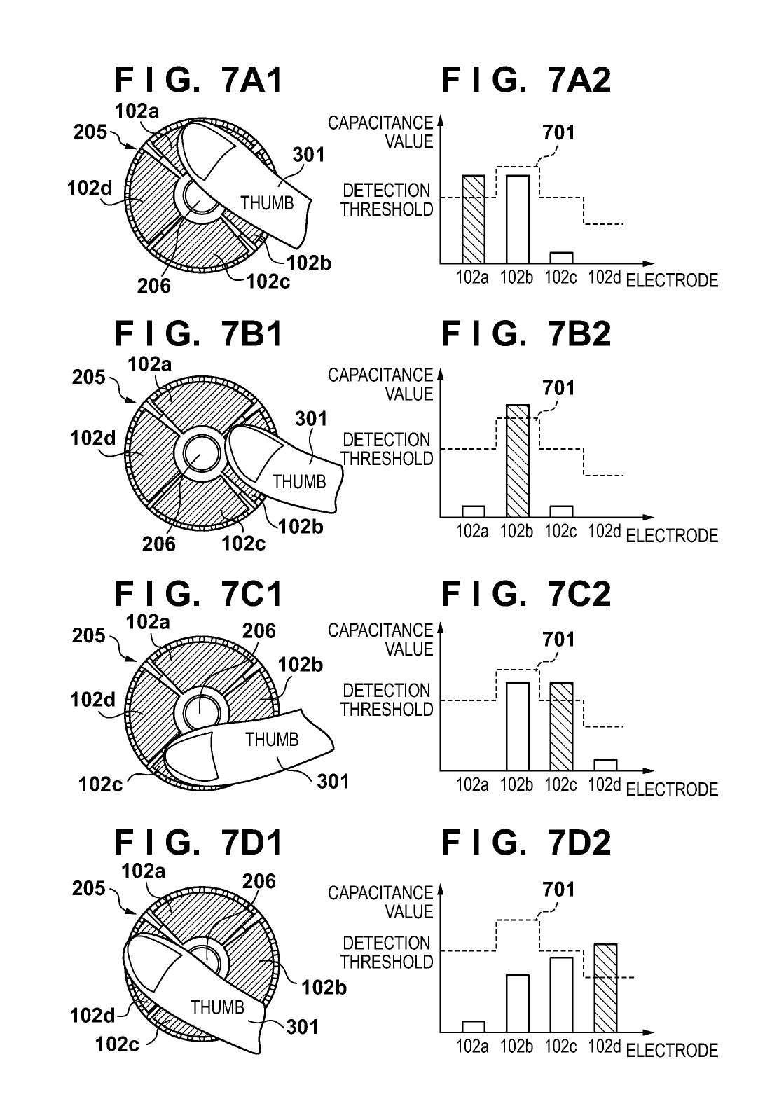

The third embodiment will be described with reference to FIGS. 7A1 to 7D2.

FIG. 7A1 is a schematic view showing a case in which the user touches an electrode 102a corresponding to the upper direction. FIG. 7A2 shows the capacitance value of each electrode at this time. FIG. 7B1 is a schematic view showing a case in which the user touches an electrode 102b corresponding to the right direction. FIG. 7B2 shows the capacitance value of each electrode at this time. FIG. 7C1 is a schematic view showing a case in which the user touches an electrode 102c corresponding to the lower direction. FIG. 7C2 shows the capacitance value of each electrode at this time. FIG. 7D1 is a schematic view showing a case in which the user touches an electrode 102d corresponding to the left direction. FIG. 7D2 shows the capacitance value of each electrode at this time.

Referring to FIGS. 7A1, 7A2, 7B1, 7B2, 7C1, 7C2, 7D1, and 7D2, a different detection threshold 701 is set for each electrode. The detection threshold of an electrode which is easy to touch while gripping a camera is set to be larger than that of an electrode which is difficult to touch while gripping the camera. This can suppress, as much as possible, the possibility of an erroneous operation due to the inaccessibility.

Furthermore, the user may shoot an image while holding the camera in the vertical position. When an attitude detection unit 107 detects the vertical position, it is possible to solve the problem that it is difficult to touch by changing the detection threshold set for each electrode. Although a description will be omitted in FIGS. 6A and 6B, it is possible to further suppress the possibility of an erroneous operation by adding the processing in step S409 of FIG. 4B.

According to each of the above-described embodiments, in an image capturing apparatus such as a single-lens reflex camera for which the user operates a plurality of operation members formed by touch sensors while holding the apparatus with the hand, the touch detection sensitivity of the operation member on the far side with respect to a grip portion is set to be higher than that of an operation member on the near side. This can prevent, as much as possible, unwanted operation of a plurality of sensors due to the arrangement of the touch sensors, or an erroneous operation due to poor accessibility of the touch sensor.

Note that in each of the above-described embodiments, a case in which the plurality of touch sensor electrodes 102a to 102d are arranged for determining an operated portion of the sub electronic dial 205 as a single operation member has been explained. The present invention, however, is not limited to this. Separate operation members such as an upper button, lower button, left button, and right button may be provided instead of the sub electronic dial 205, and a plurality of sensor electrodes may be arranged in the plurality of operation members. By applying each of the above-described embodiments, it is possible to correctly determine an operated button among the plurality of operation members such as the upper button, lower button, left button, and right button.

Although an image capturing apparatus such as a single-lens reflex camera has been exemplified as an electronic apparatus in each of the above-described embodiments, the present invention is not limited to this, and is applicable to any electronic apparatus for which the user can operate an operation member formed by touch sensors while holding the apparatus with the hand. That is, the present invention is applicable to a PDA, a cellular phone, a cellular image viewer, a music player, a game machine, an electronic book reader, and the like.

It is also assumed that the user operates an operation member while gripping the end portion of an electronic apparatus even though the apparatus has no portion which is explicitly considered as a grip portion unlike a single-lens reflex camera. In an electronic apparatus for which the user can operate a plurality of operation members formed by touch sensors while holding the electronic apparatus with the hand, therefore, the touch detection sensitivity of the operation member on the far side with respect to the end portion of the housing of the electronic apparatus is set to be higher than that of the operation member on the near side, thereby obtaining the above-described effects. As a method of setting the touch detection sensitivity to be higher, a capacitance value obtained in an electrode is multiplied by a predetermined value in the above-described first embodiment. Other methods may be used to adjust the sensitivity as long as it is possible to give relatively different touch detection sensitivities. For example, an amplification circuit may be provided between each electrode and the capacitance sensor IC, and an output value from the touch detection electrode of the operation member not on the near side but on the far side with respect to the end portion of the housing of the electronic apparatus may be electrically amplified. To the contrary, the sensor IC 101, the CPU 103, or the amplification circuit provided between the sensor IC 101 and the touch detection electrode of the operation member not on the far side but on the near side with respect to the end portion of the housing of the electronic apparatus may decrease an output value from the touch detection electrode.

In the above-described embodiments, by assuming that a portion which is easy to touch and a portion which is difficult to touch change depending on the attitude, in which the camera is in the vertical position or the horizontal position, determined based on information from the attitude detection unit 107, an electrode for which the sensitivity should be increased is changed depending on the attitude. Unlike the above embodiments, instead of always controlling to change, depending on the attitude, an electrode for which the sensitivity should be increased, the control operation may be performed according to ON/OFF of an automatic portrait/landscape switching function for the display direction. The automatic portrait/landscape switching function for the display direction rotates the display direction of displayed contents according to the vertical position or horizontal position which has been determined based on the information from the attitude detection unit 107. The user can arbitrarily turn on or off the automatic portrait/landscape switching function through a setting menu or the like by operating the operation unit 111. If the automatic portrait/landscape switching function is ON and the electronic apparatus is in the horizontal position (normal position), displayed contents on the display unit 105 are displayed by considering the vertical direction of the electronic apparatus as the upper-and-lower direction. If the electronic apparatus is in the vertical position, displayed contents on the display unit 105 are displayed by considering the horizontal direction of the electronic apparatus as the upper-and-lower direction. That is, the displayed contents in the vertical position are obtained by rotating the displayed contents in the horizontal position by 90°. If the automatic portrait/landscape switching function is OFF, the displayed contents are not rotated irrespective of the attitude of the electronic apparatus, and are always displayed by considering the vertical direction of the electronic apparatus as the upper-and-lower direction. When the automatic portrait/landscape switching function is OFF, it can be assumed that the user uses the electronic apparatus so that a direction in which he/she looks at the display unit 105 does not change even if the attitude of the electronic apparatus changes. This applies to, for example, a case in which the user lies down while holding the electronic apparatus in the horizontal position. In this case, it can be assumed that a way of holding the electronic apparatus by the user does not change even if the attitude of the electronic apparatus changes. If, therefore, the automatic portrait/landscape switching function is OFF, a control operation of changing an electrode for which the sensitivity should be increased depending on the attitude is not performed, and the electrode with a high sensitivity is fixed irrespective of the attitude. On the other hand, if the automatic portrait/landscape switching function is ON, it can be assumed that a direction in which the user looks at the display unit 105 changes as the attitude of the electronic apparatus changes. This applies to, for example, a case in which the user changes the attitude of the electronic apparatus from the horizontal position to the vertical position while standing. If the automatic portrait/landscape switching function is ON, therefore, a control operation (similar to that of the above-described flowchart) of changing an electrode for which the sensitivity should be increased depending on the attitude is performed.

Although a case has been explained in the above-described embodiments in which a capacitance value obtained in an electrode is multiplied by a predetermined value to adjust the sensitivity, the user may set an adjustment amount.

Furthermore, an example of a capacitance type has been explained as a touch sensor type in the above-described embodiments. In the capacitance type, a capacitance value changes when the user only comes close to a touch sensor instead of directly touching it. This particularly presents the problem addressed by the present application, thereby obtaining high effects of the present invention. Note that even if other types of touch sensors are used, the ball of a finger which touches an operation member on the far side with respect to the end portion of the housing may actually touch or press another operation member, thereby presenting the problem addressed by the present application. The present application, therefore, is not limited to a capacitance type touch sensor, and is applicable to various types of touch sensors such as a resistance film type touch sensor, a surface acoustic wave type touch sensor, an infrared type touch sensor, an electromagnetic induction type touch sensor, an image recognition type touch sensor, and an optical sensor type touch sensor.

One hardware component may control the CPU 103 or a plurality of hardware components may share the processing, thereby controlling the apparatus as a whole. The present invention has been described in detail based on the preferred embodiments. The present invention, however, is not limited to the specific embodiments, and includes various modes within the spirit and scope of the present invention. The above-described embodiments are merely examples of the present invention, and can be combined as needed.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium). In such a case, the system or apparatus, and the recording medium where the program is stored, are included as being within the scope of the present invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-158455, filed Jul. 19, 2011, which is hereby incorporated by reference herein in its entirety.

What is claimed is:

1. An electronic apparatus comprising:
an operation unit;
a plurality of touch detection units each configured to detect a touch input to said operation unit;
a sensitivity adjustment unit configured to perform adjustment so that a sensitivity of a touch detection unit of said plurality of touch detection units, which is arranged on a far side with respect to a specific end portion of said electronic apparatus, becomes higher than a sensitivity of a touch detection unit of said plurality of touch detection units, which is arranged on a near side with respect to the specific end portion; and
a determination unit configured to determine an operated portion of said operation unit based on output values from said plurality of touch detection units, which have been adjusted by said sensitivity adjustment unit.

2. An electronic apparatus comprising:
a plurality of operation units;
a plurality of touch detection units configured to detect touch inputs to said plurality of operation units;
a sensitivity adjustment unit configured to perform adjustment so that a sensitivity of a touch detection unit of said plurality of touch detection units, which is arranged on a far side with respect to a specific end portion of said electronic apparatus, becomes higher than a sensitivity of a touch detection unit of said plurality of touch detection units, which is arranged on a near side with respect to the specific end portion; and
a determination unit configured to determine an operated operation unit of said plurality of operation units based on output values from said plurality of touch detection units, which have been adjusted by said sensitivity adjustment unit.

3. An electronic apparatus comprising:
an operation unit;
a plurality of touch detection units each configured to detect a touch input to said operation unit;
a sensitivity adjustment unit configured to perform adjustment so that a sensitivity of a touch detection unit of said plurality of touch detection units, which is arranged on a far side with respect to a grip portion of said electronic apparatus, becomes higher than a sensitivity of a touch detection unit of said plurality of touch detection units, which is arranged on a near side with respect to the grip portion; and
a determination unit configured to determine an operated portion of said operation unit based on output values from said plurality of touch detection units, which have been adjusted by said sensitivity adjustment unit.

4. An electronic apparatus comprising:
a plurality of operation units;
a plurality of touch detection units configured to detect touch inputs to said plurality of operation units;
a sensitivity adjustment unit configured to perform adjustment so that a sensitivity of a touch detection unit of said plurality of touch detection units, which is arranged on a far side with respect to a grip portion of said electronic apparatus, becomes higher than a sensitivity of a touch detection unit of said plurality of touch detection units, which is arranged on a near side with respect to the grip portion; and
a determination unit configured to determine an operated operation unit of said plurality of operation units based on output values from said plurality of touch detection units, which have been adjusted by said sensitivity adjustment unit.

5. The apparatus according to claim 1, wherein said sensitivity adjustment unit adjusts the sensitivity by amplifying the output value from said touch detection unit arranged on the far side.

6. The apparatus according to claim 1, wherein said sensitivity adjustment unit adjusts the sensitivity by cutting down the output value from said touch detection unit arranged on the near side.

7. The apparatus according to claim 1, wherein said sensitivity adjustment unit adjusts the sensitivity by setting a high threshold for determining that said touch detection unit arranged on the near side has been touched.

8. The apparatus according to claim 1, wherein when a ratio of a second largest output value to a largest output value of the output values from said plurality of touch detection units, which have been adjusted by said sensitivity adjustment unit, is not less than a threshold, said determination unit invalidates an operation represented by the output values.

9. The apparatus according to claim 1, further comprising
an attitude detection unit configured to detect an attitude of said apparatus,
wherein said sensitivity adjustment unit changes a touch detection unit for which a sensitivity is to be increased, depending on the attitude of said apparatus which has been detected by said attitude detection unit.

10. The apparatus according to claim 3, further comprising
a grip detection unit configured to detect whether the grip portion is held,
wherein when it is not detected that the grip portion is held, said sensitivity adjustment unit does not perform the adjustment.

11. The apparatus according to claim 1, wherein said apparatus is an image capturing apparatus for capturing an object image.

12. The apparatus according to claim 1, wherein said touch detection unit is a capacitance type touch sensor electrode.

13. A control method of an electronic apparatus which has an operation unit and a plurality of touch detection units each configured to detect a touch input to the operation unit, the method comprising:
a sensitivity adjustment step of performing adjustment so that a sensitivity of a touch detection unit of the plurality of touch detection units, which is arranged on a far side with respect to a specific end portion of the electronic apparatus, becomes higher than a sensitivity of a touch detection unit of the plurality of touch detection units, which is arranged on a near side with respect to the specific end portion; and
a determination step of determining an operated portion of the operation unit based on output values from the plurality of touch detection units, which have been adjusted in the sensitivity adjustment step.

14. A control method of an electronic apparatus which has a plurality of operation units and a plurality of touch detection units configured to detect touch inputs to the plurality of operation units, the method comprising:
a sensitivity adjustment step of performing adjustment so that a sensitivity of a touch detection unit of the plurality of touch detection units, which is arranged on a far side with respect to a specific end portion of the electronic apparatus, becomes higher than a sensitivity of a touch detection unit of the plurality of touch detection units, which is arranged on a near side with respect to the specific end portion; and
a determination step of determining an operated operation unit of the plurality of operation units based on output values from the plurality of touch detection units, which have been adjusted in the sensitivity adjustment step.

15. A control method of an electronic apparatus which has an operation unit and a plurality of touch detection units each configured to detect a touch input to the operation unit, the method comprising:
a sensitivity adjustment step of performing adjustment so that a sensitivity of a touch detection unit of the plurality of touch detection units, which is arranged on a far side with respect to a grip portion of the electronic apparatus, becomes higher than a sensitivity of a touch detection unit of the plurality of touch detection units, which is arranged on a near side with respect to the grip portion; and
a determination step of determining an operated portion of the operation unit based on output values from the plurality of touch detection units, which have been adjusted in the sensitivity adjustment step.

16. A control method of an electronic apparatus which has a plurality of operation units and a plurality of touch detection units configured to detect touch inputs to the plurality of operation units, the method comprising:
a sensitivity adjustment step of performing adjustment so that a sensitivity of a touch detection unit of the plurality of touch detection units, which is arranged on a far side with respect to a grip portion of the electronic apparatus, becomes higher than a sensitivity of a touch detection unit of the plurality of touch detection units, which is arranged on a near side with respect to the grip portion; and
a determination step of determining an operated operation unit of the plurality of operation units based on output values from the plurality of touch detection units, which have been adjusted in the sensitivity adjustment step.

17. A non-transitory computer-readable storage medium storing a program for causing a computer to execute the control method according to claim 13.

18. A non-transitory computer-readable storage medium storing a program for causing a computer to execute the control method according to claim 14.

19. A non-transitory computer-readable storage medium storing a program for causing a computer to execute the control method according to claim 15.

20. A non-transitory computer-readable storage medium storing a program for causing a computer to execute the control method according to claim 16.
